(19) United States
(12) Patent Application Publication
(10) Pub. No.: US 2016/0041308 A1
(43) Pub. Date: Feb. 11, 2016

(54) CERAMIC HAVING A FUNCTIONAL COATING

(71) Applicant: CERAMTEC-ETEC GMBH, Lohmar (DE)

(72) Inventors: Gordian Kramer, Altbach (DE); Gert Richter, Königsbach-Stein (DE); Lars Schnetter, Wimbach (DE); Joachim Bill, Weil Der Stadt (DE); Mirjam Eisele, Gärtringen (DE)

(21) Appl. No.: 14/778,730

(22) PCT Filed: Mar. 28, 2014
(86) PCT No.: PCT/EP2014/056319

§ 371 Date: Sep. 21, 2015

(30) Foreign Application Priority Data
Mar. 28, 2013 (DE) 10 2013 205 636.2

(51) Int. Cl. G02B 1/113; B05D 3/02; B05D 1/18; G02B 1/115; G02B 1/14

(52) U.S. Cl. CPC G02B 1/113; G02B 1/115; G02B 1/14; B05D 1/18; B05D 3/0254

(57) ABSTRACT

The present invention relates to material composites composed of a ceramic substrate having a functional coating and to the production and use of said material composites.

The subject matter of the present invention is a material composite composed of a ceramic substrate having functional layers and the production and use of said material composite. In particular, the invention also relates to transparent ceramic substrates having preferably optical functional layers.

For many optical applications, such as covering lenses, protective lenses in optical units, and scanner windows, optical units without strong optical dispersion are necessary, i.e., they must be substantially colorless. In contrast thereto, specific coloring can be desirable or necessary, particularly in the design or jewelry field or in applications in the field of optical filtering. Thus, the specific color design (dispersion) is a central material property of nearly every optical component. It is very difficult to deposit an anti-reflective layer without coloring. For this purpose, a specific coordination of layer materials and substrate and a multi-layer structure are usually necessary.

In general, optical components are composed of glass, glass ceramic, or plastics, and less frequently also monocrystalline sapphire (Al₂O₃ ceramic). Common to glasses and plastics is that they have low strength, temperature resistance, and scratch resistance. In addition to these disadvantages, glasses have a heavy weight, are easily broken into pieces, and usually have a colored cloudiness. In contrast, plastics have low hardness and, in some cases, absorb water. Inorganic monocrystals are associated with very high costs in the production thereof and therefore are often uneconomical.

In order to improve the optical properties of the aforementioned substrates or in order to fulfill a wide range of functions, glasses, plastics, glass ceramics, and monocrystals can be coated with optical functional layers.

The functional layer fulfills a function adapted and tailored to the field of use. There are many different possibilities of use. The optical layers can be deposited by means of different coating methods, such as deposition from the vapor phase (PVD and CVD methods) and by applying liquids (sol) by means of, e.g., sol-gel or spin-on methods. It is also possible to produce functional layers, particularly optical functional layers, by means of thermal conversion (oxidation).

The coating of substrates for optical usage purposes in coating methods specifically adapted to the optical unit is known. Because of the low temperature resistance of glasses and plastics, maximum coating temperatures of approximately 500° C. for glasses and approximately 200° C. for plastics are possible. Therefore, the coating temperature and thus the energy input into the coating have upper limits.

The energy input can be controlled and rises, e.g., as a result of higher coating temperatures or the use of plasma or bombardment with ions. Greater energy input positively influences the layer properties, such as layer density or layer compactness, layer adhesion, or scratch resistance, and therefore the highest possible energy input is desired (see also, for example, DE 102004027842 A1).

In the case of hard-material layers for use on machining tools, there are higher demands for the layer adhesion of the substrate/layer composite than in many optical applications. Therefore, high energy input is advantageous and strived for here also.

Thus, the problem addressed by the invention is that of providing an improved material composite composed of a substrate and a functional coating.

The problem is solved by the use of ceramic substrates having a functional coating, wherein the ceramic substrates do not change the properties thereof, particularly the optical properties thereof, up to temperatures of approximately 1200° C. Because of this property, coating methods that achieve significantly higher energy input into the substrate/layer composite are also possible.

A functional coating according to the invention comprises or consists of at least one functional layer, wherein the functional layer can have, for example, an optical, thermal, mechanical, or chemical function or a combination of these functions.

In the context of this invention, the term “ceramic substrates” is understood to mean polycrystalline ceramics in particular. However, monocrystalline substrates such as sapphire substrates should also be included under this term. A ceramic, excluding monocrystals that are composed of ceramic powders in the original state, is distinguished by a method for production from ceramic powders, which are shaped into substrates by pressing or slip-casting or extrusion technology of any type and are solidified, subsequently or simultaneously with the shaping, by sintering. The ceramic substrates are preferably at least 99 vol % crystalline. Glass ceramic production methods and products should be expressly excluded from this term.

The material composite, composed of the ceramic substrate and the functional coating, that is presented here can be an unsupported ceramic having a coating or can be part of a more complex component, such as part of an architectural device, e.g., as a sight glass, or also can substitute parts of a bulletproof glass pane.

In contrast to substrates known from the prior art which are composed of glass, glass ceramic, or plastics, ceramic substrates have high temperature resistance, strength, and stiffness. They have high layer internal stress, because of which the ceramic substrate does not warp during the coating. Therefore, coatings can be deposited at high temperatures and/or with high energy input without impairing the substrate.

A further advantage of ceramic substrates over glass and plastic substrates is the better adhesion between the substrate and the coating. It is assumed that the better adhesion is based on a ceramic bond between the material partners.

Glass and, in particular, plastic substrates are susceptible to chemical attacks. Contact with wet-chemical media can cause the applied layers to tear or detach. Because of the chemical bonding, coatings on ceramic substrates are not chemically attacked, or are chemically attacked significantly less.

Polycrystalline ceramics have the advantage over monocrystals, such as sapphire, that polycrystalline ceramics are simpler to produce and easier to mechanically process. Therefore, they are also significantly more economical. Sapphire monocrystals also have the disadvantage of being doubly refractive, i.e., optically anisotropic. In contrast, polycrystalline ceramics such as spinel are singly refractive and optically isotropic.

According to an especially preferred embodiment of the invention, the ceramic substrate and/or the functional coating and/or the material composite is transparent. These material composites can be used as a substitute for all coated transparent substrates, but with the advantages described above.

For example, a material composite having a colorless optical functional layer that has a thickness of less than 100 μm, preferably less than 1 μm, especially preferably less than 0.5 μm, and highly especially preferably less than 0.15 μm, can have a fluctuation range of the RIT (real in-line transmission) of less than 10%, preferably less than 5%, and especially preferably less than 1%, in a wavelength range of 420 to 650 nm.

In the context of this invention, the term “colorless” refers to that which does not absorb any light. It relates to an object that does not interact with electromagnetic radiation in the visible (VIS) range. With regard to the composite material composed of the ceramic substrate and the functional coating, this means that the material composite does not reflect and/or absorb light in the VIS range and therefore does not have a tint or colored cloudiness or exhibit a coloring.

By means of a low fluctuation of the RIT over the surface of the coating, a high-quality functional coating is achieved. If the material composite is colorless, it is suitable particularly for optical applications. For photographic applications, for example, in which natural colors are desired, an optical component having such a composite material can avoid the falsification of colors.

In principle, functional coatings that contain at least one functional layer that selects the transmission of electromagnetic waves in an absorbing, reflecting, or scattering manner, i.e., restricts the transmission of electromagnetic waves in dependence on wavelength, are of course also possible. Especially preferably, this selection occurs in the VIS range.

In a further preferred embodiment of the invention, the functional coating can comprise at least one functional layer that has a reflection-reducing effect. The term “reflection-reducing effect” should be understood to mean that the material composite composed of the ceramic substrate and the functional coating has a higher RIT than the ceramic substrate without the functional coating. The following relationship applies:

RITₘₐₓ=1−Rₘₐₓ

Rₘₐₓ=1−2×((n_{surroundings}−n_{substrate})/(n_{substrate}+n_{surroundings}))
Rₘₐₓ=maximum reflection
n_{surroundings}=index of refraction of the surrounding medium
n_{substrate}=index of refraction of the material composite

Another preferred embodiment of the invention comprises at least one functional layer that has a reflection-increasing effect, so that the material composite composed of the ceramic substrate and the functional coating has higher reflection than the ceramic substrate without the functional coating. The following relationship is fulfilled:

Rₘₐₓ=1−2×((n_{surroundings}−n_{substrate})/(n_{substrate}+n_{surroundings}))
Rₘₐₓ=maximum reflection
n_{surroundings}=index of refraction of the surrounding medium
n_{substrate}=index of refraction of the material composite

Ceramic substrates having such coatings are more or less reflective and can be used in particular for the surface construction of mechanically, thermally, or chemically highly loaded parts.

The functional coating can also consist of a stack having several functional layers, particularly selected from the functional layers described above. Such functional coatings can be used, for example, as multi-ply anti-reflective layers.

An especially preferred embodiment of the invention is distinguished in that fingerprints are little visible on the material composite. This can be achieved in that, for example, the material composite has a layer having an index of refraction of 1.38 to 1.55, preferably 1.45 to 1.50, as the outermost layer. The layer index of refraction is thus similar to the index of refraction of lipids or of sebum. By adapting the index of refraction of the functional coating to the index of refraction of sebum (n=1.48), the visibility of fingerprints on the surface has been successfully significantly limited. By means of this adaptation, it is possible to neutralize disturbing effects caused by, for example, skin contact.

The functional coatings described above can be applied to the ceramic substrate by means of fundamentally known methods. The methods to be used differ from methods known from the prior art in that a ceramic substrate, particularly a transparent ceramic substrate, is coated, wherein higher energy input into the coating leads to improved quality of the functional coating. The functional layers can be deposited on the ceramic substrate by means of, for example, PVD, sol-gel, spin-on-disk, PACVD, or CVD methods. Of course, a combination of the methods for different functional layers is also possible.

Especially preferably, the at least one functional layer is applied by means of a sol-gel method and baked at temperatures between 300 and 1200° C., preferably between 500 and 700° C. This method provides high-quality coatings and is relatively economical.

Thus, production methods preferred according to the invention are deposition from the vapor phase by means of PVD and CVD, and sol-gel or spin-on coating, and the thermal conversion of a previously applied metal layer.

If temperature-resistant substrates are used, the thermal CVD method is a possibility for depositing layers with high energy input. The layer deposition typically occurs at temperatures between 900 and 1200° C. Plasma-assisted CVD methods such as PACVD enable layer deposition at temperatures of 50 to 500° C.

PVD methods for depositing optical layers typically reach temperatures up to approximately 450° C. In order to increase the energy input, there is a possibility for these methods, particularly for the arc PVD method, of working with plasma assistance and/or ion bombardment during the coating process. The plasma assistance or the ion bombardment leads to a densification of the applied layer.

A further possibility for producing coatings with high energy input is the use of a sol-gel method as a coating method. The sol film applied to the substrate is baked in a furnace after the application and drying, and therefore the energy input can be realized by means of the baking temperature. The upper limit of the temperature range is typically approximately 500° C. when glassy or glass-ceramic substrates are used.

The methods described are currently not used industrially because of the relatively high coating temperatures and the inadequate quality of the coatings, such as layer thickness homogeneity in the case of PACVD methods or the droplets occurring in the arc PVD method.

Particularly for an optical coating, layer thicknesses should vary by less than 1% of the layer thickness. However, with the current PACVD methods, the fluctuations are approximately 30% of the average layer thickness.

In the arc PVD method, metal of a target is melted by means of an arc and thus a metal vapor is produced, which condenses on the colder component surface. During the melting, small punctiform melt baths, on which bubbles can form, arise on the target. If these bubbles burst, droplets form, which are accelerated toward the component because of the voltage on the component. These egg-shaped metal droplets are integrated into the deposited layer. They are inhomogeneities that impair the functionality of the coating.

In tests, a specimen of a polycrystalline, transparent spinel ceramic was coated with titanium by means of the arc PVD method and then converted into TiO₂ by means of thermal oxidation. The PVD coating was performed in 30 minutes at a temperature of 500° C. (in principle, coating temperatures between 50 and 800° C. are possible) and a pressure of 10⁻² Pa. The thermal oxidation occurs in an atmosphere having the mixture ratio of 80% nitrogen and 20% oxygen at temperatures around 1000° C. and a holding time of two hours. In comparison with the maximally possible temperature for glass of approximately 500° C., it was possible to double the temperature to 1000° C. The energy requirement for heating up a specimen of the geometry 90×90×5 mm having a specimen weight of 145 g from room temperature to 500° C. is 54.9 kJ. To heat up the same specimen to 1000° C., an energy amount of 100.8 kJ is required. The result is an energy input of 59.5 kJ, which is increased in comparison with the energy input that is maximally possible for glass. In comparison with plastic substrates having the maximally possible coating temperature of 200° C., it was possible to increase the energy input by 91.6 kJ.

In SEM analyses, it was possible to confirm a homogeneous layer thickness. After the thermal oxidation, no droplets were present. It is suspected that the droplets were melted or sintered by the high temperatures during the thermal oxidation and that it was thereby possible to achieve levelling. An amorphous titanium dioxide was produced by the oxidation. The layer thickness of the amorphous titanium dioxide layer is 0.066 μm or 66 μm on average. The index of refraction of the amorphous titanium dioxide layer decreases with increasing wavelength (n @ 400 nm=3.08 and n @ 780 mm=2.55) and is n=2.637 on average. By means of the index of refraction of TiO₂, which is higher than that of spinel (index of refraction n=1.69 to 1.72), the reflection of the material composite composed of the ceramic substrate and the optical coating is increased in comparison with the reflection of the ceramic substrate without the functional layer.

By means of this test, it was shown that a coating with higher energy input is possible. In comparison with the prior art specified in DE 102004027842 A1, the applied layer had a more homogeneous layer thickness; the problem of the droplet formation did not exist. It was possible to achieve a reflection increase of the substrate/coating composite.

The layer adhesion of the amorphous titanium dioxide layer was determined by means of a Nano Scratch Tester from the firm CSM Instruments, a group of companies of Anton-Paar.

The specimen was tested by means of a test body having a ball and 2-μm test-body tip rounding. The scanning load was 0.4 mN; the test force was 40 mN; the measuring distance had a total length of 400 μm. The test force was applied at a speed of 80 mN/μm. The traversing speed of the test body was 800 μm/min. The measurements were performed at 24° C. in air atmosphere having 40% humidity.

The following values were determined: The first critical load (Lc₁) that led to first changes of the layer was 25.8 mN on average. The changes can be described as color changes of the layer and as an increase in the coefficient of friction.

When the specimen was loaded further, the second critical load (LC₂) was detected at 28.2 mN on average. A further typically occurring force (LC₃) could not be detected in the measurements. By means of the calculation in accordance with the ball/plane application, a Hertzian stress of 61.21 N/m² results for the LC₂ value from the selected test parameters. The modulus of elasticity of the coating was used for the calculation.

The nanohardness of the amorphous titanium dioxide layer was determined by means of an Ultra Nanoindentation Tester from the firm CSM Instruments, a group of companies of Anton-Paar.

For the measurements, the specimen was adhesively bonded to a carrier plate composed of aluminum having the dimensions 20×20×20 mm. The test was performed with a Berkovich indenter and progressive load application. The test force was 20 μN and 50 μN and was held at the load maximum for 2 s. The load was applied at a speed of 600 μN/s. They were performed at 24° C. in air atmosphere having 40% humidity.

The depths of penetration by the selected forces were 5 nm at a load of 20 μN and 12 nm at a load of 50 μN. Measured values of the load of 20 μN penetrate into the layer by less than 10% of the layer thickness and thus give values that are reliable as per DIN EN ISO 14577-4.

With a test load of 20 μN, it was possible to determine a layer hardness H_{IT} (O&P) of 4594 MPa, which layer hardness was determined in accordance with the method of Oliver and Par. The test with a test load of 50 μN resulted in a layer hardness H_{IT} (O&P) of 6636.7 MPa, but this value can be influenced by the substrate material because of the depth of penetration of 20% of the layer thickness.

In general, a ceramic substrate according to the invention, having a functional coating, is distinguished in particular by the following properties, wherein this list is not to be considered exhaustive:
Improved layer adhesion in the substrate/layer composite because of the use of ceramic materials whose material properties are similar to those of the coating, e.g., with regard to thermal expansion, lattice spacing of the crystal lattice, etc.
In the case of sol-gel methods, an increase in the layer thickness and the layer hardness because of higher sintering temperatures
Reduction of the layer stresses
Improvement in the toughness of the ceramic substrate having the functional coating
Improved tribological properties such as abrasive wear and thermochemical wear
Improved scratch resistance

The invention is explained in more detail below by means of examples.

### EXAMPLE 1

Increase in the transmittance of transparent, polycrystalline ceramics by depositing anti-reflective or anti-reflection layers: The anti-reflective layer or the layer composite has the task of adapting the index of refraction at the substrate/air transition in order to minimize reflections. The transmission of electromagnetic waves (light) in the wavelength range of 300 nm to 4000 nm, preferably in the visible range between 380 nm and 800 nm, can thereby be increased. All of the aforementioned methods are suitable for applying or producing these coatings.

Below, the production of material composites composed of transparent, polycrystalline spinel ceramic substrates having multi-layer anti-reflective coatings by means of a sol-gel method is described as a concrete embodiment example.

Round, transparent, polycrystalline spinel ceramic substrates from two different batches were used (for dimensions, see table 2). The ceramic substrates of batch 1 have a maximum transmittance of 86% without a coating, the ceramic substrates of batch 2 a maximum transmittance of 79.7%.

TABLE 2

| | | |
|---|---|---|
| Diameter [mm] | 26.0 | 26.8 |
| Thickness [mm] | 6.0 | 3.8 |
| Outer appearance | Transparent, clear | Appears milky |
| Max. transmittance [%] | 86.0 | 79.7 |

The ceramic substrates were coated layer-by-layer with a polycation, poly(diallyldimethylammonium chloride) (PDDA) solution, and a tetraethoxysilane (TEOS) sol in order to produce an amorphous SiO₂ anti-reflective layer.

To coat the ceramic substrates, the cleaned ceramic substrates were dipped into the PDDA solution and the TEOS solution. After each of these dipping steps, the ceramic substrates were rinsed by means of highly pure water and dried by means of nitrogen. The stated coating steps are referred to below as a cycle.

10 to 30 cycles were performed in each case in order to approximately produce a layer thickness of 115 nm.

Then the coated ceramic substrates were heated to 500° C. at a heat-up rate of 5° C./min and aged there in air for 10 hours in order to bake the coating.

Table 3 shows a summary of the results of the ceramic substrates coated with the functional coating. The layer thickness d was measured on the SEM on fractured specimens that have been sawed into. Δd refers to the deviation from the optimally sought layer thickness of the coating of 115 nm. ITᵥ gives the in-line transmission valve of the ceramic substrate without the functional coating, and ITₙ gives the in-line transmission value with the functional coating. ΔIT gives the difference of the in-line transmission after and before the functional coating.

TABLE 3

Specimen

| | 1 | 2 | 3 | 4 |
|---|---|---|---|---|
| d [nm] | 94 | 94 | 94 | 126 |
| Δd [nm] | −21 | −21 | −21 | +11 |
| ITᵥ [%] | 74.7 | 77.8 | 85.0 | 76.9 |
| ITₙ [%] | 85.5 | 86.6 | 94.2 | 86.0 |
| ΔIT [%] | +10.8 | +8.8 | +9.2 | +9.1 |

In parallel, sol-gel layers such as SiO₂ single layers and TiO₂-MO (TiO₂—SiO₂-mixed oxide)-SiO₂ anti-reflective multi-layer coatings were successfully deposited. The baking temperature was increased from 480° C. to 600° C. and 700° C.

Comparative measurements were performed on the specimens with the sol-gel single-layer coating. One specimen was coated by means of the current standard methods for glasses; the baking temperature was 480° C. A second specimen was treated with the same coating and an increased baking temperature of 700° C.

The following measurements were performed on the specimens.

The tape test as per DIN EN ISO 2409 was passed in the sudden pull-off (<1 s) and in the fast pull-off (<1 min).

The transparency was measurably increased in comparison to the typical baking temperature of 480° C. For the single-layer coating, the transparency values at 600 nm reached 96.06% at 480° C. and 96.62% at the higher energy input of 600° C. baking temperature.

The layer adhesion of the sol-gel silicon dioxide layer was determined by means of a Nano Scratch Tester of the firm CSM Instruments.

The specimen was tested by means of a test body having a ball and 5-μm test-body tip rounding. The scanning load was 3 mN; the test force was 200 mN; the measuring distance had a total length of 500 μm. The test force was applied at a speed of 400 mN/μm. The traversing speed of the test body was 1000 μm/min. The measurements were performed at 24° C. in air atmosphere having 40% humidity.

The following values were determined for the first specimens with 480° C. baking temperature. A first critical load (Lc₁) that led to first changes of the layer could not be detected.

In the measurements, the critical force LC₃, indicated by a failure of the polycrystalline ceramic, occurred before the failure of the sol-gel layer at the critical load LC₂. The value LC₃ for the failure of the substrate is 142.6 mN on average.

When the specimen was loaded further, the second critical load (LC₂) was detected at 152.9 mN on average. By means of the calculation in accordance with the ball/plane application, a Hertzian stress of 96.22 N/m² results for the LC₂ value from the selected test parameters.

The layer adhesion of the standard baking temperature of 480° C. for glasses is already good. However, it was possible to further increase the layer adhesion significantly by means of the increased baking temperature of 700° C. The test of the specimen with the high baking temperature of 700° C. was performed with settings identical to those of the previously described test of the specimen with the lower baking temperature of 480° C.

Again, the failure of the substrate was detected first. The critical load LC₃ was 151.4 mN in this measurement. The sol-gel coating did not fail until an excellent value for LC₂ of 186.3 mN. By means of the calculation in accordance with the ball/plane application, a Hertzian stress of 117.74 N/m² results for the LC₂ value from the selected test parameters.

It was possible to increase the resistance to Hertzian stress by 80% in comparison to the lower baking temperature.

It was possible to improve the layer adhesion by approximately 20% as a result of the higher baking temperature.

The nanohardness of the sol-gel silicon dioxide layer was determined by means of an Ultra Nanoindentation Tester from the firm CSM Instruments. For the measurements, the specimen was adhesively bonded to a carrier plate composed of aluminum having the dimensions 20×20×20 mm. The test was performed with a Berkovich indenter and progressive load application. The test force was 20 μN and was held at the load maximum for 2 s. The load was applied at a speed of 240 μN/s. The measurements were performed at 24° C. in air atmosphere having 40% humidity.

It was possible to determine a layer hardness H_{IT} (O&P) of 609.2 MPa for the specimen with a baking temperature of 480° C., which layer hardness was determined in accordance with the method of Oliver and Par. The specimen with the increased baking temperature of 700° C. achieved a layer hardness H_{IT} of 1017.3 MPa. This value is better than the value of the standard process by approximately 60%.

It was found that the higher energy input resulting from the baking temperature increased by 220° C. significantly improves the layer properties. It was thereby possible to increase the energy input by 25.2 kJ, which results in significantly increased layer properties.

In addition, it was possible to show by means of SEM images that it was possible to level out polishing scratches still present on the surface. In comparative examinations, it was possible to show that it was possible to narrow down the biaxial strength limits of coated specimens by means of the coating.

For this purpose, ultimate bending strengths were determined in accordance with the standard DIN ISO 6474 by means of biaxial bending testing. The bending strength was tested on a Zwick Roell testing system of the model Z050. For each test result, 15 biaxial plates were fractured by means of a testing device compliant with standards. The test bodies are composed of opaque Al₂O₃ ceramic having a metal titanium coating, which is applied by means of PACVD and has a layer thickness of 3 μm. The following values were determined (see table 1):

TABLE 1
Average values of the biaxial strengths and the standard deviation

| Specimen type | Stress in MPa | Fmax Ø | Standard deviation |
|---|---|---|---|
| Uncoated | 962.2 | 4354.1N | 979.4 |
| Coated on one | 713.6 | 4552.7 | 367.4 |
| side | | | |
| Coated on both | 730.4 | 4608.1 | 137.7 |
| sides | | | |

As can be seen in table 1, the bending strength of the specimens increases with the coating and the standard deviation, calculated over the 15 measured specimens in each case, decreases. The specimen bending strength is increased by the coating; the fluctuation range of the bending strength measurements becomes smaller.

### EXAMPLE 2

Coating of the surface of the ceramic substrate with materials that have a higher index of refraction than the substrate, as a result of which the substrate having the coating can be used as a mirror: the substrate can be transparent or opaque. A metal coating can be applied in conjunction with an anti-scratch layer, e.g., composed of SiO₂.

The material composite provided according to the invention, composed of transparent or opaque, particularly polycrystalline ceramics having functional layers, is especially suitable, because of the properties of the substrate/layer composite, for components that are exposed to high temperature, high mechanical and tribological loads, high pressures, impacts (bombardment), or undirected forces and stresses.

Furthermore, the material composites according to the invention can be used in the case of increased requirements for safety and material stiffness and in lightweight construction. The following are stated only as examples:
Watch glass
Protective panes for furnace systems, vacuum systems, blast booths, cutting machines and systems
Objective protection panes (cameras/microscopes)
Sight glasses for, e.g., scanning electron microscopes
Instrument panes for high pressure ranges
Display panes (smartphone, laptop, operating elements)
Architectural element (floor tiles, floor pane, floodlight panes)
Panes that can be driven over (runways)
Panes for underwater floodlights (high pressure)
Panes in ship construction (military and civilian), above-water and underwater (research submarines), nature/underwater observation ships
Panes in air travel and space travel
Bulletproof glass/protective glazing
Optical high-performance mirrors in telescopes, laser systems, satellites
Prisms for measuring devices (no coloring of the light; the substrate is purely white)

Therefore, the following are provided according to the invention
Functional layers on transparent or opaque polycrystalline ceramic, for example on ZrO₂, Al₂O₃, SiC, Si₃N₄, spinel (AlMgO), AlN, SiAlON, and/or AlON ceramic
Functional layers on transparent or opaque monocrystal (for example, sapphire or the like)
Predominantly inorganic functional coatings such as anti-reflective layers, reflective layers, thermally conductive layers, IR-absorbing, IR-reflecting coatings, heating layer, photochromic layer, electrochromic layer, thermochromic layer, radiation-reflecting layer, or anti-scratch layer against mechanical abrasion
Functional coatings for increased or reduced microhardness of the substrate

1.-18. (canceled)

19. A material composite comprising a ceramic substrate having a functional coating, which functional coating comprises at least one functional layer.

20. The material composite according to claim 19, wherein the ceramic substrate comprises a polycrystalline ceramic or a monocrystal.

21. The material composite according to claim 20, wherein the polycrystalline ceramic is at least 99 vol % crystalline.

22. The material composite according to claim 19, wherein the ceramic substrate or the functional coating or the material composite is transparent.

23. The material composite according to claim 19, wherein the functional coating makes the material composite more mechanically, thermally, and/or chemically resistant.

24. The material composite according to claim 19, wherein the at least one functional layer selects the transmission of electromagnetic waves in an absorbing, reflecting, or scattering manner, i.e., restricts said transmission in dependence on wavelength, particularly in the visible range.

25. The material composite according to claim 19, wherein the material composite has at least one colorless functional layer and/or a colorless ceramic substrate.

26. The material composite according to claim 19, wherein the at least one functional layer of the functional coating has a thickness of less than 100 μm, preferably less than 1 μm, and highly especially preferably less than 0.15 μm, and has a fluctuation range of the real in-line transmission of less than 10% in a wavelength range of 420 to 650 nm.

27. The material composite according to claim 19, wherein the at least one functional layer has a reflection-reducing effect, so that the material composite composed of the ceramic substrate and the functional layer has a higher RIT than the ceramic substrate without the functional layer, according to the following relationship:
RITₘₐₓ=1−Rₘₐₓ
Rₘₐₓ=1−2×((n_{surroundings}−n_{substrate})/(n_{substrate}+n_{surroundings}))
Rₘₐₓ=maximum reflection
n_{surroundings}=index of refraction of the surrounding medium
n_{substrate}=index of refraction of the material composite

28. The material composite according to claim 19, wherein the at least one functional layer has a reflection-increasing effect, so that the material composite composed of the ceramic substrate and the functional layer has higher reflection than the ceramic substrate without the functional layer, according to the following relationship:
Rₘₐₓ=1−2×(n_{surroundings}−n_{substrate})/(n_{substrate}+n_{surroundings}))
Rₘₐₓ=maximum reflection
n_{surroundings}=index of refraction of the surrounding medium
n_{substrate}=index of refraction of the material composite

29. The material composite according to claim 19, wherein the functional coating comprises or consists of several functional layers.

30. The material composite according to claim 19, wherein the functional coating has, as an outermost layer in contact with the surroundings, a layer having an index of refraction n of 1.38 to 1.55.

31. The material composite according to claim 19, wherein the functional coating has, as an outermost layer in contact with the surroundings, a layer that levels out surface damage and thereby increases the strength of the material composite and/or narrows down the limit values of the strengths and/or reduces the standard deviation.

32. The material composite according to claim 19, wherein the functional coating was produced with an energy input between 55 and 135 kJ into the functional layer, whereby the layer adhesion in the scratch test is increased by at least 10 mN.

33. The material composite according to claim 19, wherein the functional coating was produced with an energy input between 55 and 135 kJ into the functional layer, whereby the average layer hardness H_{IT} (O&P) in the nanoindentation test is increased by at least 100 MPa.

34. The material composite according to claim 19, wherein the functional coating was produced with an energy input between 55 and 135 kJ into the functional layer, whereby the average resistance to Hertzian stress is increased by at least 5 N/m².

35. The material composite according to claim 23, wherein the functional coating comprises or consists of several functional layers.

36. A method for producing a material composite composed of a ceramic substrate having a functional coating, which functional coating comprises at least one functional layer, comprising depositing the at least one functional layer is deposited on the ceramic substrate by a method selected from the group consisting of physical vapor deposition, sol-gel, spin-on-disk, plasma assisted chemical vapor deposition and chemical vapor deposition.

37. The method according to claim 35, wherein the at least one functional layer is applied by means of a sol-gel method and at least said functional layer is baked at a temperature between 300 and 1200° C.
